(19) United States
(12) Patent Application Publication
(10) Pub. No.: US 2008/0313717 A1
(43) Pub. Date: Dec. 18, 2008

(54) Communication-Address Issuing Apparatus, Communication-Mediating Apparatus, Communication-Mediating Method, Program, and Recording Medium

(75) Inventor: Masahiro Inoue, Syunan-shi (JP)

Correspondence Address: KRATZ, QUINTOS & HANSON, LLP, 1420 K Street, N.W., Suite 400, WASHINGTON, DC, 20005, US

(73) Assignees: MUSUHI ENTERPRISE CORPORATION, Hadano-shi (JP); Masahiro INOUE, Syunan-shi (JP)

(21) Appl. No.: 10/580,716

(22) PCT Filed: Feb. 18, 2005
(86) PCT No.: PCT/JP05/02542

§ 371 Date: May 25, 2006

(51) Int. Cl. G06F 21/00

(52) U.S. Cl. 726/5

(57) ABSTRACT

[Problem] To provide a communication-address issuing apparatus, a communication-mediating apparatus, and so on capable of enhancing the security level to prevent someone else from intercepting exchange of communication without permission.

[Solving Means] There are provided an address-information storage section 11 for storing an issued pair of communication addresses uniquely assigned to each pair of particular users, together with original addresses of the users and associating information for the pair of communication addresses; a receiving section 30 for receiving data sent to an assigned communication address, together with the communication address and the transmission-source address; a search section 31 for searching communication addresses stored in the address-information storage section 11 for an address identical to the received communication address; a verification section 32 for verifying the received transmission-source address with the original address when an address identical to the communication address is found; and a transmission section 33 for reading out another communication address which constitutes the pair with the communication address to set it as a transmission-source address and for transmitting the data to the original address corresponding to the communication address when the transmission-source address matches the original address as a result of the verification.

### TECHNICAL FIELD

The present invention relates to communication-address issuing apparatuses, communication-mediating apparatuses, communication-mediating methods, programs, and recording media.

### BACKGROUND ART

As disclosed in Patent Document 1 to be described later, there are known structures for storing the email addresses of communication partners communicating with each other and one encrypted email address obtained by performing reversible encryption of numbers sequentially assigned to these partners, to communicate with each other using this encrypted email address for the purpose of guaranteeing the confidentiality of communication, particularly to enable communication between the partners while the addresses thereof are concealed from each other.

In such a structure, each party sends an email to the encrypted email address, and thereby an email server that has received the email decrypts an encrypted portion to obtain the sequence numbers to acquire the email address of each party so that the same email contents are sent to each party.

### Patent Document 1: Japanese Unexamined Patent Application Publication No. 2003-224606

### DISCLOSURE OF INVENTION

### Problems to be solved by the Invention

Because this encrypted email address is a so-called common address, even though this email address is encrypted, any email sent to the encrypted email address arrives at both parties, even if the email is sent by someone else. If phishing emails, which have recently become widespread, are sent, there may be a risk of the recipient being tricked into leaking various pieces of personal information to outsiders without knowing it.

It is assumed that the email addresses of both parties A and B and one email address obtained by applying reversible encryption to numbers sequentially given to both the parties are stored to allow party A and party B to communicate with each other by using that encrypted email address. If it is found that this encrypted email address has been leaked to others by a mistake on the part of party A, the sequence numbers need to be discarded, the email addresses of both parties A and B need to be re-registered using different individual sequence numbers, and then these sequence numbers need to be encrypted to generate a different encrypted email address, which needs to be reported to both parties A and B. Thereafter, both parties A and B re-register the new encrypted email address for use for exchanging emails between both parties. Not only does this require that the fact of such a leak be reported, but also party B is forced to perform additional work as a result of party A's mismanagement in leaking the encrypted email address. This is an inevitable feature of systems using a common address.

The present invention has been made in light of these circumstances, and it is intended to provide a communication-address issuing apparatus, a communication-mediating apparatus assuming the use of the issuing apparatus, a communication-mediating method, a program, and a recording medium which enhance the level of security to prevent someone else from intercepting exchange of communication without permission (useful particularly in preventing fraud by means of phishing emails, which have recently become widespread) and which, even if some communication address is known to and used by someone else, are capable of rejecting its use.

### Means for Solving the Problems

For this purpose, a communication-address issuing apparatus according to the present invention is basically characterized by including:

communication-address issuing means for uniquely assigning one pair of communication addresses to each pair of particular users between whom mediation is made and issuing the pair of communication addresses together with associating information for the pair of communication addresses;

address-information storage means for storing the issued pair of communication addresses uniquely assigned to each pair of particular users, together with original addresses of the users and the associating information; and

communication-address report means for transmitting a unique pair of pieces of communication-address information for each pair of users to respective original addresses based on each of the pieces of storage information stored in the address-information storage means.

Here, the phrase “to uniquely assign one pair of communication addresses to each pair of particular users between whom mediation is to be made and issue the pair of communication addresses” means to provide one user (even the same user) with a different communication address if the other user is changed. A communication address issued in this manner and transmitted to each party is used not only as the address of a particular partner each time communication with the partner is carried out, but also for authentication of oneself (the transmitter) [by verifying this communication address with one's original address (packets in communication include the address of the transmission source)] in a communication-mediating apparatus to be described later.

Then, the communication addresses are stored in the address-information storage means, together with the original addresses of these users and information associating the pair of communication addresses, and are transmitted and reported to each pair of particular users as the addresses of individual partners by the communication-address report means.

Each of the transmitted and reported communication addresses is an address used by a certain person to perform transmission to another person and is eventually used to authenticate the certain person who has carried out the transmission.

For example, a communication address used by party A for transmission to party B is used to authenticate party A in the main body of the communication-mediating apparatus, to be described later, which has received it. More specifically, a search is made to see whether the communication address used by party A as an address for party B exists as a communication address used when party A transmits to party B, in the addresses stored in the address-information storage means, by the communication-mediating apparatus, to be described later, which has received it. Furthermore, when the address exists, the transmission-source address of party A (transmission source) received together with the communication address is verified with the original address stored in the address storage means, corresponding to the communication address. When they match, the communication address is authenticated as one used by party A for transmission to party B. A different communication address is used for a communication address used by party A for transmission to party C.

On the other hand, a communication address used by party B for transmission to party A (different from the communication address used by party A for transmission to party B) is used for authentication of party B by the main body of the communication-mediating apparatus, to be described later, which has received it. More specifically, a search is made to see whether the communication address used by party B as an address for party A exists as a communication address used when party B transmits to party A, in the addresses stored in the address-information storage means, by the communication-mediating apparatus, to be described later, which has received it. Furthermore, when the address exists, the transmission-source address of party B (transmission source) received together with the communication address is verified with the original address stored in the address storage means, corresponding to the communication address. When they match, the communication address is authenticated as one used by party B for transmission to party A.

According to the above-described structure, the communication-address issuing means uniquely assigns one pair of communication addresses to each pair of particular users between whom mediation is made and issues the pair of communication addresses, and the address-information storage means stores the issued pair of communication addresses uniquely assigned to each pair of particular users, together with the original addresses of the users and the associating information. For example, assuming that party A's original address is α, a communication address used by party A to party B is issued as A. Also assuming that party B's original address is β, a communication address used by party B to party A is issued as B by the communication-address issuing means. These addresses α and A and addresses β and B are stored in the address-information storage means together with associating information (registration Nos. and associating No. information in embodiments to be described later) for linking them.

Then, a unique pair of pieces of communication-address information for each pair of users (the communication address “A” for party A and the communication address “B” for party B in the above-described example) are transmitted and reported to respective original addresses (to party A's original address α and to party B's original address β in the above-described example) by the communication-address report means based on each of the stored pieces of storage information.

Thereinafter, this pair of users perform transmission and reception to and from respectively assigned communication addresses of the partners (for example, the communication address A to party B from party A and the communication address B to party A from party B). As described above, each of these communication addresses is used for self-authentication rather than for partner-authentication (for example, the communication address A to party B from party A is used for authentication of party A, and the communication address B to party A from party B is used for authentication of party B). Structures for this purpose correspond to the communication-mediating apparatuses of Claims 3 and 4 and the communication-mediating methods of Claims 5 and 6.

Even if a third party forges a transmission-source address and impersonates party A to perform transmission to party B at the communication address for party B, the impersonation made by the third party is detected when party A checks a transmission and reception history, if such a transmission and reception history is stored in transmission-and-reception-history storage means, as shown in, for example, Claim 4.

In such a case, it is necessary to modify one address in each pair of communication addresses issued (the communication address used by party A for transmission to party B in the above-described example). In that case, the communication-address issuing means issues a new communication address (for authentication of the side where modification is made) only for the modified address, and the address-information storage means updates only the communication address to be modified to the new communication address and stores it (Claim 2). As a result, the other user (party B in the above-described example) does not have to do annoying work such as modification (of the communication address used by party B for party A). Furthermore, since a pair of communication addresses is uniquely assigned to each pair of particular users between whom mediation is to be made and the pair of communication addresses is issued, it is not necessary to modify the communication address used by party A for party C.

The structure of the communication-mediating apparatus for mediating communication between particular users according to Claim 3 is characterized by including:

address-information storage means for storing an issued pair of communication addresses uniquely assigned to each pair of particular users, together with original addresses of the users and associating information for the pair of communication addresses;

reception means for receiving data sent to a communication address assigned for communication between particular users, together with the communication address and the transmission-source address;

search means for searching communication addresses stored in the address-information storage means for an address identical to the communication address received by the reception means;

verification means for verifying the received transmission-source address with the original address stored in the address storage means corresponding to the communication address when an address identical to the communication address is found as a result of the searching; and

transmission means for reading out another communication address which constitutes the pair with the communication address and which is stored in the address-information storage means to set it as a transmission-source address and for transmitting the data to the original address corresponding to the communication address when the transmission-source address matches the original address as a result of the verification made by the verification means.

With the structure of the communication-mediating apparatus, the address-information storage means of Claims 1 and 2 are used in common. By using the reception means, the search means, the verification means, and the transmission means together with the address-information storage means, communication between particular users is mediated.

In short, the operation of this communication-mediating apparatus is specified as the communication-mediating method of Claim 5 as-is. Here, the communication-mediating method is a method executed with a structure including:

address-information storage means for storing an issued pair of communication addresses uniquely assigned to each pair of particular users, together with original addresses of the users and associating information for the pair of communication addresses;

reception means for receiving data sent to a communication address assigned for communication between particular users, together with the communication address and the transmission-source address;

search means for searching the address-information storage means for the communication address received by the reception means;

verification means for verifying the received transmission-source address with the original address stored in the address storage means corresponding to the communication address; and

transmission means for transmitting the data to an original address of the other user. This method executes the steps of:

receiving, with the reception means, data sent to a communication address assigned for communication between particular users, together with the communication address and the transmission-source address;

searching, with the search means, communication addresses stored in the address-information storage means for an address identical to the received communication address;

verifying, with the verification means, the received transmission-source address with the original address stored in the address storage means corresponding to the communication address when an address identical to the communication address is found as a result of the searching; and

reading out another communication address which constitutes the pair with the communication address and which is stored in the account-information storage means to set it as a transmission-source address and transmitting, with the transmission means, the data to the original address corresponding to the communication address when the transmission-source address matches the original address as a result of the verification.

Here, if a search is made by the search means to see whether an address identical to the communication address A received from party A exists in the communication addresses stored in the address-information storage means and if the identical communication address A is found as a result of the search, the verification means verifies the transmission-source address α received from party A with the original address α stored in the address storage means corresponding to the communication address A. When party A's transmission-source address α matches the original address α as a result of the verification, it is authenticated that the communication address A to party B used by party A for transmission to party B was used by party A for transmission to party B together with party A's original address α.

Because this authentication was successful, the other communication address B which constitutes the pair with the communication address A and which is stored in the account-information storage means is read out by the transmission means to set it as a transmission-source address, and the above-described data is transmitted by the transmission means to party B's original address β corresponding to the communication address B.

Also in the cases of data transmission from party B to party A, from party A to party C, and from party C to party A, communication addresses are uniquely assigned to each pair of parties, and the other conditions are the same as in the above-described examples.

On the other hand, the structure of the communication-mediating apparatus according to Claim 4 has a structure further including transmission-and-reception-history storage means for storing a transmission and reception history of the reception means and the transmission means and for making the transmission and reception history available for output, in addition to the structure of the communication-mediating apparatus of Claim 3.

As described above, since communication is carried out such that every instance of one-to-one data transmission and reception is authenticated with this structure, impersonation made by a third party is substantially prevented. Nevertheless, a third party's impersonation of an authentic entity cannot be completely eliminated. In such a case, records of a communication history (transmission and reception history) may help the impersonated party notice impersonation made by a third party. For example, even if a third party forges party A's transmission-source address α and impersonates party A to transmit data to communication address A to party B, the impersonation made by the third party is detected when party A checks the transmission and reception history because the transmission and reception history stored in the transmission-and-reception-history storage means is stored.

When such impersonation made by a third party is found, one address in each pair of communication addresses issued (the communication address A used by party A to communicate with party B in the example above) is modified, as shown in the structure of the above-described Claim 2. More specifically, the communication-address issuing means issues a new communication address A′ (for authentication of the side where modification is made) only for one address (A in the example above), and the address-information storage means updates only the communication address A to be modified to the new communication address A′ and stores it. As a result, annoying work of changing a communication address is not imposed on user party C on the other side, such as changing the address from B to B′. Furthermore, since a pair of communication addresses is uniquely assigned to each pair of particular users between whom mediation is to be made and the pair of communication addresses is issued, it is not necessary to modify the communication address (C, for example) to party C from party A.

The structure of Claim 5 or Claim 6 is specified by looking at the above-described apparatus structure from a different perspective, that is, in the form of a method.

Among them, the structure of Claim 5 corresponds to the apparatus structure of Claim 3 and, more specifically, is a communication-mediating method carried out with a structure including:

address-information storage means for storing an issued pair of communication addresses uniquely assigned to each pair of particular users, together with original addresses of the users and associating information for the pair of communication addresses;

reception means for receiving data sent to a communication address assigned for communication between particular users, together with the communication address and the transmission-source address;

search means for searching the address-information storage means for the communication address received by the reception means;

verification means for verifying the received transmission-source address with the original address stored in the address storage means corresponding to the communication address; and

transmission means for transmitting the data to an original address of the other user. This communication-mediating method executes the steps of:

receiving, with the reception means, data sent to a communication address assigned for communication between particular users, together with the communication address and a transmission-source address;

searching, with the search means, communication addresses stored in the address-information storage means for an address identical to the received communication address;

verifying, with the verification means, the received transmission-source address with the original address stored in the address storage means corresponding to the communication address when an address identical to the communication address is found as a result of the searching; and

reading out another communication address which constitutes the pair with the communication address and which is stored in the account-information storage means to set it as a transmission-source address and transmitting, with the transmission means, the data to the original address corresponding to the communication address when the transmission-source address matches the original address as a result of the verification.

Furthermore, the structure of Claim 6 corresponds to the apparatus structure of Claim 4 and, more specifically, is a communication-mediating method carried out with a structure including:

address-information storage means for storing an issued pair of communication addresses uniquely assigned to each pair of particular users, together with original addresses of the users and associating information for the pair of communication addresses;

reception means for receiving data sent to a communication address assigned for communication between particular users, together with the communication address and the transmission-source address;

search means for searching the address-information storage means for the communication address received by the reception means;

verification means for verifying the received transmission-source address with the original address stored in the address storage means corresponding to the communication address;

transmission means for transmitting the data to an original address of the other user; and

transmission-and-reception-history storage means for storing a transmission and reception history of the reception means and the transmission means. This communication-mediating method executes the steps of:

receiving, with the reception means, data sent to a communication address assigned for communication between particular users, together with the communication address and the transmission-source address;

searching, with the search means, communication addresses stored in the address-information storage means for an address identical to the received communication address;

verifying, with the verification means, the received transmission-source address with the original address stored in the address storage means corresponding to the communication address when an address identical to the communication address is found as a result of the searching;

reading out another communication address which constitutes the pair with the communication address and which is stored in the account-information storage means to set it as a transmission-source address and transmitting, with the transmission means, the data to the original address corresponding to the communication address when the transmission-source address matches the original address as a result of the verification; and

outputting the stored transmission and reception history, with the transmission-and-reception-history storage means, upon instruction to the transmission-and-reception-history storage means.

On the other hand, the structures of Claim 7 to Claim 10 propose a computer program read out and executed by a computer so that the computer serves as one of the apparatuses according to the above-described Claims 1 and 2 or one of the apparatuses according to the above-described Claims 3 and 4.

More specifically, as structures for solving the above-described problems, a disclosure is made of a computer program readable and executable by a computer to carry out the processing performed by each means of the communication-address issuing apparatus specified in the above-described Claim 1 or Claim 2 or the processing performed by each means of the communication-mediating apparatus specified in Claim 3 or Claim 4, by using the structure of the computer. It goes without saying that these structures may be provided not only as a computer program but also in the form of a recording medium having stored therein a program having the same functions (Claim 11), as described later. In that case, the term “computer” may include a dedicated machine for particular processing in addition to the structure of a general-purpose computer including the structure of a central processing unit, and is not limited specifically as long as the structure of a central processing unit is included.

When such a program causing a computer to execute each of the above-described processes is read out by the computer, the same processing as that carried out by one of the means in the apparatus structure specified in Claim 1 or Claim 2 or the apparatus structure specified in Claim 3 or Claim 4 is carried out.

In addition, by executing this computer program with the use of existing hardware resources, the structure of the communication-address issuing apparatus specified in Claim 1 or Claim 2 or the structure of the communication-mediating apparatus specified in Claim 3 or Claim 4 can be easily implemented as a new application with the existing hardware. Furthermore, as a result of such a computer program being recorded on the above-described recording medium, the program can be easily distributed and sold as a software product. In addition, the structure of the recording medium may be the structure of an internal storage device, such as a RAM and a ROM, and the structure of an external storage device, such as a hard disk, in addition to the above-described format, and it goes without saying that any recording medium falls in the scope of the recording medium specified by the present invention, as long as such a program is recorded on that recording medium.

Functions for carrying out some of the processing carried out by the means described in Claim 7 to Claim 10 may be achieved by functions built into a computer (functions built into the computer as hardware or functions realized by an operating system or another application program installed in the computer), and the above-described program may include a command for calling or linking the functions achieved by the computer.

This is because substantially the same structure is provided when some of the processes specified in Claim 7 to Claim 10 are performed by some of the functions achieved by, for example, the operating system, and some of the functions of the operating system for achieving those functions can be called or linked, even if a program or a module for achieving the functions is not directly recorded.

The above-described program itself is to be used. In addition, as described later, the program can be recorded in a recording medium for distribution or sale, or can be transmitted via communication and treated as something to be transferred.

Among them, the structure of Claim 7 corresponds to the structure of Claim 1, and its specific structure is a communication-address issuing computer program which is read and executed by a computer to cause the computer to function as:

communication-address issuing means for uniquely assigning one pair of communication addresses to each pair of particular users between whom mediation is made and issuing the pair of communication addresses together with associating information for the pair of communication addresses;

address-information storage means for storing the issued pair of communication addresses uniquely assigned to each pair of particular users, together with original addresses of the users and the associating information; and

communication-address report means for transmitting a unique pair of pieces of communication-address information for each pair of users to respective original addresses based on each of the pieces of storage information stored in the address-information storage means.

The structure of Claim 8 corresponds to the structure of the above-described Claim 2, and its specific structure is characterized in that when one of the issued pair of communication addresses is modified, the communication-address issuing means issues a new communication address only for the modified one, and the address-information storage means updates only the communication address to be modified to the new communication address and stores it.

The structure of Claim 9 corresponds to the structure of the above-described Claim 3, and its specific structure is a communication-mediating computer program which is read and executed by a computer to cause the computer to function as:

address-information storage means for storing an issued pair of communication addresses uniquely assigned to each pair of particular users, together with original addresses of the users and associating information for the pair of communication addresses;

reception means for receiving data sent to a communication address assigned for communication between particular users, together with the communication address and the transmission-source address;

search means for searching communication addresses stored in the address-information storage means for an address identical to the communication address received by the reception means;

verification means for verifying the received transmission-source address with the original address stored in the address storage means corresponding to the communication address when an address identical to the communication address is found as a result of the searching; and

transmission means for reading out another communication address which constitutes the pair with the communication address and which is stored in the address-information storage means to set it as a transmission-source address and for transmitting the data to the original address corresponding to the communication address when the transmission-source address matches the original address as a result of the verification made by the verification means.

The structure of Claim 10 corresponds to the structure of the above-described Claim 4, and its specific structure is a communication-mediating computer program which is read and executed by a computer to cause the computer to function as:

address-information storage means for storing an issued pair of communication addresses uniquely assigned to each pair of particular users, together with original addresses of the users and associating information for the pair of communication addresses;

reception means for receiving data sent to a communication address assigned for communication between particular users, together with the communication address and the transmission-source address;

search means for searching communication addresses stored in the address-information storage means for an address identical to the communication address received by the reception means;

verification means for verifying the received transmission-source address with the original address stored in the address storage means corresponding to the communication address when an address identical to the communication address is found as a result of the searching;

transmission means for reading out another communication address which constitutes the pair with the communication address and which is stored in the address-information storage means to set it as a transmission-source address and for transmitting the data to the original address corresponding to the communication address when the transmission-source address matches the original address as a result of the verification made by the verification means; and

transmission-and-reception-history storage means for storing a transmission and reception history of the reception means and the transmission means and making the transmission and reception history available for output.

Furthermore, as described above, the structure of Claim 11 specifies a computer-readable recording medium having stored therein the computer program described in one of Claim 7 to Claim 10. In short, these computer programs can be recorded in recording media and handled as something to be transacted or actually executed.

The above-described apparatuses and computers for executing programs (or programs read out from the above-described recording media) or computers constituting the above-described system may be, but are not limited to, one structure (such as a stand-alone computer). Alternatively, they may be composed of a plurality of computers (such as a plurality of servers) constituting a network, and the processing carried out in each of the above-described steps may be set in programs such that the processing is carried out in a distributed manner in those computers (via an appropriate communication configuration, if necessary).

### ADVANTAGES OF THE INVENTION

With the structures of the communication-address issuing apparatuses, communication-mediating apparatuses, communication-mediating methods, computer programs, and recording media described in Claim 1 to Claim 11 according to the present invention, a communication address is assigned and issued as an address for each communication partner, and the assigned communication address is eventually used for authentication of the sender himself or herself, while the sender uses the assigned communication address as the address for his or her partner. Therefore, not only can the communication partners perform communication without knowing each other's original addresses, but also the communication address and the original address are used by a communication-mediating apparatus for authentication of the identification of the sender, as described above. This blocks communication associated with impersonation made by a third party and prevents someone else from intercepting exchange of communication without permission, thus contributing to enhancement of the security level.

The present invention is advantageous particularly in that even if a communication address becomes known to and used by a third party in some way (impersonation made by a third party), it is first verified whether the communication address corresponds to communication address information stored in address-information storage means (the existence is confirmed through searching); and then it is also checked whether the original address corresponding to the communication address (stored in the address-information storage means together with a recorded relationship with the communication address) matches the address included, for example, in packets, and as a result of the checking, if the original address and the latter address (the address included, for example, in the packets) do not match (do not match as a result of the checking) (double authentication is carried out by searching and checking), the use of the address can be rejected. Against known phishing (impersonation) fraud, which is defined as “as a result of transmission to a partner at the destination by impersonating a sender, the recipient becomes a victim of fraud by falsely recognizing the transmission as an email from the impersonated partner himself or herself”, “the use of a communication address” with a structure according to the present invention prevents the recipient from receiving emails from the communication address used for himself or herself (to avoid falsely recognizing the sender), unless the legitimate recipient leaks the communication address, since only the legitimate recipient knows the communication address used for himself or herself. While it is possible to forge a transmitter number for communication with a partner when email addresses and telephone numbers are made public, a communication address (transmitter number) known only by the recipient can prevent or detect phishing fraud by forging the transmitter number.

Furthermore, according to the structures of Claims 4, 6, and 10, since a transmission and reception history is stored and is made available for output, even if a third party forges a communication address A to party B from party A and party A's original address α and impersonates party A to transmit data to the communication address A used to party B, impersonation made by the third party is found when party A himself or herself checks the transmission and reception history, because the communication history (transmission and reception history) is stored as described above.

When such impersonation made by a third party is found, one address in each pair of communication addresses issued (communication address A used by party A for transmission to party B in the above-described example) is modified, as shown in the structures of Claim 2 and Claim 8. More specifically, the communication-address issuing means issues a new communication address A′ (for authentication of the side where modification is made) only for one address (A in the example above), and the address-information storage means updates only the communication address A to be modified to the new communication address A′ and stores it. As a result, annoying work of changing a communication address is not imposed on party B on the other side, such as changing the address from B to B′. Furthermore, since a pair of communication addresses is uniquely assigned to each pair of particular users between whom mediation is to be made and the pair of communication addresses is issued, it is not necessary to modify the communication address (C, for example) to party C from party A.

### BRIEF DESCRIPTION OF THE DRAWINGS

FIG. 1 is an illustration of an apparatus structure showing a communication-address issuing apparatus according to an embodiment of the present invention.

FIG. 2 is an illustration showing a storage state of communication addresses and original addresses, and of associating information in address-information storage section 11.

FIG. 3 is an illustration showing a case when a unique pair of pieces of communication-address information for each pair of users are transmitted to respective original addresses based on each of the pieces of storage information stored in the address-information storage section 11.

FIG. 4 is a flowchart illustrating a processing flow of communication address issuance processing in a structure according to a first embodiment.

FIG. 5 is a screen illustration showing a browser display screen configuration which is used on a web page of a temporary-staffing-service site on the Internet, where the communication-address issuing apparatus is operating, and which is for user party A who recruits people on that web page.

FIG. 6 Similarly, FIG. 6 is a screen illustration showing a browser display screen configuration for party A.

FIG. 7 Similarly, FIG. 7 is a screen illustration showing a browser display screen configuration for party A.

FIG. 8 is a screen illustration showing a screen configuration displayed on party B's email program.

FIG. 9 is a screen illustration showing a screen configuration displayed on party A's email program.

FIG. 10 is an outlined illustration of the structure of a communication-mediating apparatus provided on a server 100, according to a second embodiment when data is transmitted from party A to a communication address used for party B.

FIG. 11 Similarly, FIG. 11 is an outlined illustration of the structure of the communication-mediating apparatus according to the second embodiment, when data is transmitted from party A to a communication address used for party C.

FIG. 12 is a flowchart for communication mediating processing in this communication-mediating apparatus.

FIG. 13 is an illustration showing a storage state of a transmission-and-reception history of a receiving section 30 and a transmission section 33 in a transmission-and-reception-history storage section 13.

FIG. 14 shows a state of a transmission and reception history in the transmission-and-reception-history storage section 13 (upper) and a state of a transmission and reception history in an email program of party A (lower).

FIG. 15 is an illustration showing a state obtained when a communication address used by party A for party B in the address-information storage section 11 is updated from 01234.aaa@dcc.jp to 43210.aaa@dcc.jp by a communication-address issuing section 20.

FIG. 16 is an illustration showing a state obtained when a communication address 43210.aaa@dcc.jp to party B from party A is reported to party A's original address aa@www.jp by a communication-address report section 21.

### DESCRIPTION OF REFERENCE SYMBOLS

10: Storage section
11: Address-information storage section
12: User-data storage section
13: Transmission-and-reception-history storage section
20: Communication-address issuing section
21: Communication-address report section
30: Receiving section
31: Search section
32: Verification section
33: Transmission section
100: Server

### BEST MODE FOR CARRYING OUT THE INVENTION

Embodiments according to the present invention will now be described by way of examples shown in the drawings.

### First Embodiment

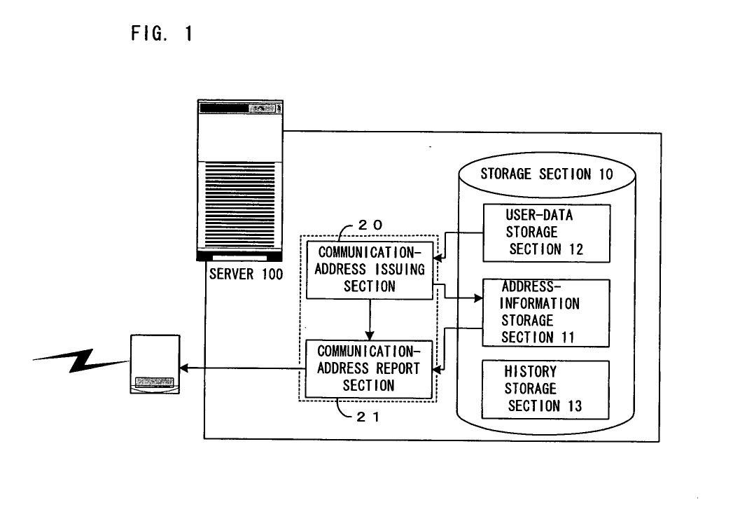

FIG. 1 is an illustration of the apparatus structure of a communication-address issuing apparatus according to an embodiment of the present invention.

As shown in the figure, this communication-address issuing apparatus is configured on the same server 100 as a communication-mediating apparatus to be described later. Here, the communication-address issuing apparatus according to the present invention is composed of a CPU; a RAM; a hard disk drive; a communication apparatus; and other components of this server 100. In short, it includes a communication-address issuing section 20; an address-information storage section 11; and a communication-address report section 21.

Of these components, the communication-address issuing section 20 and the communication-address report section 21 include the CPU, which performs arithmetic and control processing according to a read-out program to allow this apparatus to function as a communication-address issuing apparatus; a RAM for providing a working area to the CPU and for storing flags and coefficient data required for arithmetic operations by the CPU and part of a program to be executed by the CPU to allow this apparatus to function as a communication-address issuing apparatus; and other components. The address-information storage section 11 includes the above-described hard disk drive.

The communication-address issuing section 20 has a function for uniquely assigning one pair of communication addresses to each pair of particular users between whom mediation is to be made, and for issuing the pair of communication addresses together with information associating the pair of communication addresses.

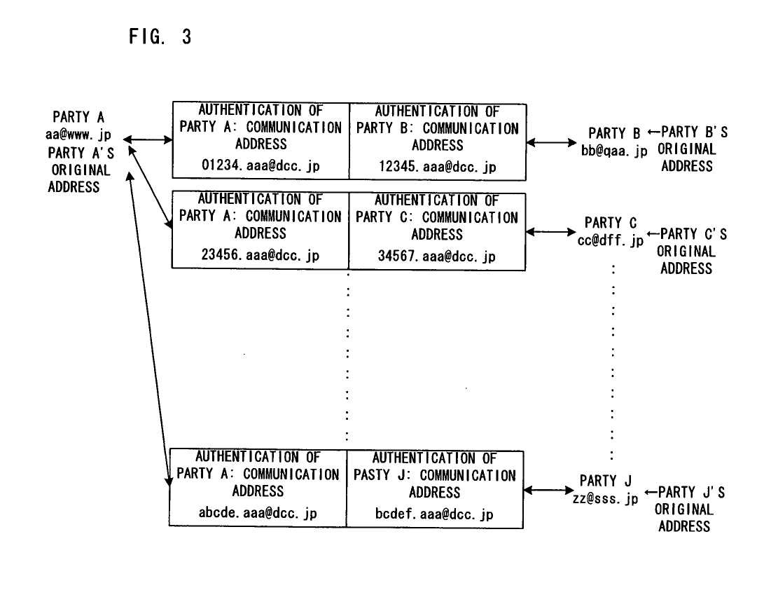

Here, the phrase “to uniquely assign one pair of communication addresses to each pair of particular users between whom mediation is to be made, and issue the pair of communication addresses” means to “cause dispatch-staff recruiters (even if they are one and the same user as party A), serving as users on one side, to have different communication addresses for different applicants for temporary staffing services (party B, party C, . . . , and party J), serving as users on the other side, in a case where this apparatus and a communication-mediating apparatus described later are used for temporary staffing services, as shown in FIG. 3 to be described later. In the example of FIG. 3, the communication address to be used by party A for party B is 01234.aaa@dcc.jp, and the communication address to be used by party B for party A is 12345.aaa@dcc.jp. On the other hand, the communication address to be used by party A for party C is 23456.aaa@dcc.jp, and the communication address to be used by party C for party A is 34567.aaa@dcc.jp. Furthermore, the communication address to be used by party A for party J is abcde.aaa@dcc.jp, and the communication address to be used by party J for party A is bcdef.aaa@dcc.jp.

A communication address issued and transmitted to each party in this manner is used not only as the address of a particular partner each time communication with the partner is carried out, but also for authentication of oneself (the transmitter) [by verifying this communication address with one's original address (packets in communication always include the address of the transmission source)] in the communication-mediating apparatus, to be described later.

For example, 01234.aaa@dcc.jp, which is the communication address to be used by party A for transmission to party B, is used for authentication of party A in the main body of the communication-mediating apparatus, to be described later, which has received the communication address. More specifically, a search is made to see whether the communication address 01234.aaa@dcc.jp used by party A as an address for party B exists as a communication address used when party A transmits to party B, in addresses stored in the address-information storage section 11, by the communication-mediating apparatus, to be described later, which has received it. Furthermore, when the address 01234.aaa@dcc.jp exists, the transmission-source address aa@www.jp of party A (transmission source) received together with the communication address is verified with the original address aa@www.jp stored in the address-information storage section 11, corresponding to the communication address 01234.aaa@dcc.jp. When they match, the communication address is authenticated as one used by party A for transmission to party B. A different communication address 23456.aaa@dcc.jp is used for a communication address used by party A for transmission to party C.

On the other hand, the communication address 12345.aaa@dcc.jp used by party B for transmission to party A (different from the communication address 01234.aaa@dcc.jp used by party A for transmission to party B) is used for authentication of party B by the main body of the communication-mediating apparatus, to be described later, which has received it. More specifically, a search is made to see whether the communication address 12345.aaa@dcc.jp used by party B as an address for party A exists as a communication address used when party B transmits to party A, in the addresses stored in the address-information storage section 11, by the communication-mediating apparatus, to be described later, which has received it. Furthermore, when the address 12345.aaa@dcc.jp exists, the transmission-source address bb@qaa.jp of party B (transmission source) received together with the communication address is verified with the original address bb@qaa.jp stored in the address-information storage section 11, corresponding to the communication address 12345.aaa@dcc.jp. When they match, the communication address is authenticated as one used by party B for transmission to party A.

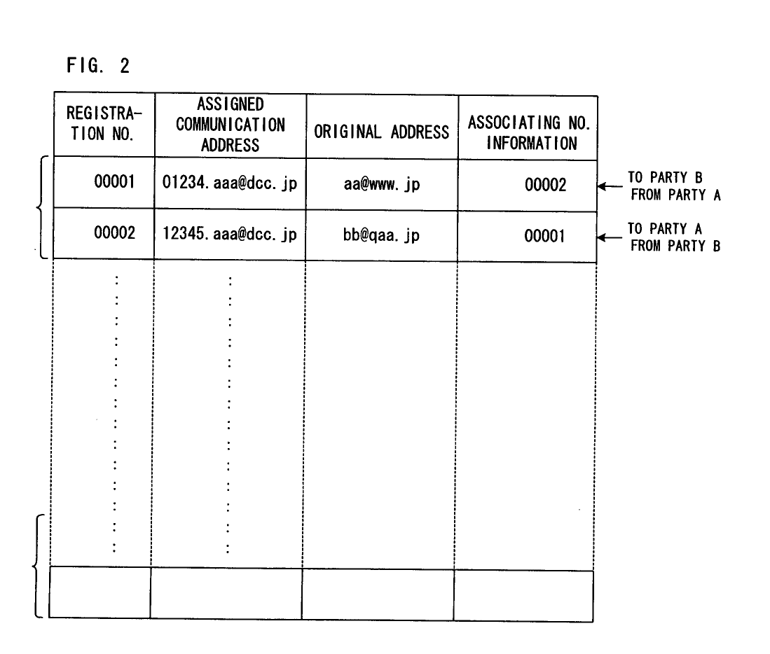

The address-information storage section 11 has a function for storing an issued pair of the communication addresses uniquely assigned to each pair of particular users together with the original addresses of these users and the associating information. FIG. 2 shows a storage state of communication addresses, original addresses, and associating information (registration Nos. and associating registration No. information) in the address-information storage section 11. More specifically, in the example of the figure, the communication address for party B from the perspective of party A is 01234.aaa@dcc.jp, and party A's original address is aa@www.jp. These pieces of information are stored as registration No. 00001, and since they are associated with registration No. 00002 shown therebelow in the drawing, associating registration No. information is also stored as 00002. On the other hand, the communication address for party A from the perspective of party B is 12345.aaa@dcc.jp, and party B's original address is bba@qaa.jp. These pieces of information are stored as registration No. 00002, and since they are associated with registration No. 00001 shown thereabove in the drawing, associating registration No. information is also stored as 00001. This address-information storage section 11 is also used in common by the communication-mediating apparatus, to be described later. Various data for these users, such as names, addresses, contact information, and preferences, are stored in a user-data storage section 12 shown together in FIG. 1. As described later, refine search data required by party A (a user on one side) to select dispatch staff requesting temporary clerical work is stored in the user-data storage section 12. More specifically, applicants for temporary clerical services (user parties B to J on the other side) register these attributes thereof as refine search data in the user-data storage section 12, and furthermore, register the original addresses thereof in the address-information storage section 11.

As shown in FIG. 1 and FIG. 3, the communication-address report section 21 includes a function for transmitting a unique pair of pieces of communication-address information for each pair of users to respective original addresses based on each of the above-described pieces of storage information stored in the address-information storage section 11. In short, the communication address 01234.aaa@dcc.jp to party B, the communication address 23456.aaa@dcc.jp to party C, . . . , and the communication address abcde.aaa@dcc.jp to party J are transmitted to party A's original address aa@www.jp. Similarly, individually different communication addresses are transmitted to party B's original address bb@qaa.jp. This is also applicable to party C, . . . , and party J.

According to the above-described structure of the embodiment, the communication-address issuing section 20 uniquely assigns a pair of communication addresses to each pair of particular users between whom mediation is to be made, and issues the pair of communication addresses. The issued pair of the communication addresses uniquely assigned to each pair of particular users are stored in the address-information storage section 11 together with the original addresses of these users and the associating information. In this embodiment, party A's original address is aa@www.jp, and the issued communication address to be used by party A for party B is 01234.aaa@dcc.jp. In addition, party B's original address is bba@qaa.jp, and the issued communication address to be used by party B for party A is 12345.aaa@dcc.jp by the communication-address issuing section 20. These addresses aa@www.jp and 01234.aaa@dcc.jp and addresses bba@qaa.jp and 12345.aaa@dcc.jp are stored in the address-information storage section 11 together with associating information, including registration Nos. and associating No. information, which links the addresses.

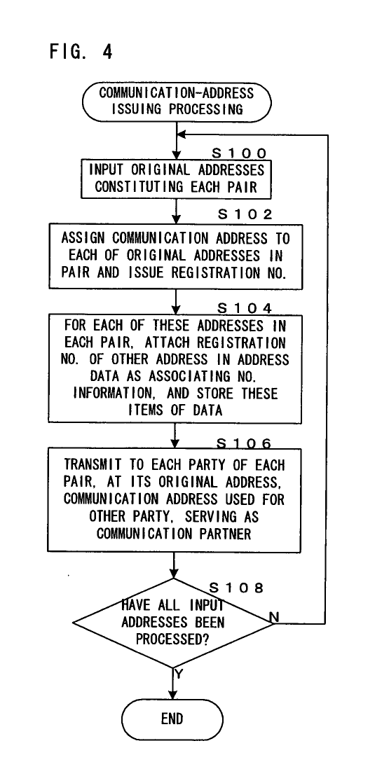

FIG. 4 is a flowchart illustrating the processing flow of communication-address issuance processing in the structure according to the above-described embodiment.

As shown in the figure, each of the original addresses constituting a pair is input first (step S100). More specifically, party A's original address aa@www.jp and party B's original address bba@qaa.jp are input as described above, when party A wishes to have a communication address for party B issued, for example. The original addresses of parties concerned are input when party A wishes to have a communication address for party C issued, when party B wishes to have a communication address for party A issued, or when party C wishes to have a communication address for party A issued, for example. Alternatively, as shown in FIG. 3, information (including original addresses) about users serving as communication partners may be registered in a database in advance, so that some of the users serving as communication partners can be selected through a search operation of the database by a user on the other side of communication to allow the information (including original addresses) and the original address of the user that has made the selection to be input, one pair per line.

Then, as shown in FIG. 2 and FIG. 3, a communication address is assigned to each of the original addresses in each pair by the communication-address issuing section 20, and a registration No. is issued (step S102).

Furthermore, as shown in FIG. 2, for each of these addresses in each pair, the communication-address issuing section 20 stores the registration No. of the other address in the address data as associating No. information, and these items of data are stored in the address-information storage section 11 (step S104).

Thereafter, as shown in FIG. 1 and FIG. 3, the communication-address report section 21 transmits to each party of each pair, at its original address, the communication address used for the other party serving as the communication partner (step S106).

Finally, it is checked to see whether all the input. original addresses constituting pairs have been processed (step S108). When not all addresses have been processed (No in step S108), the flow returns to the above-described step S100 and the above-described processing is repeated. When all addresses have been processed (Yes in step S108), the communication address issuance processing ends.

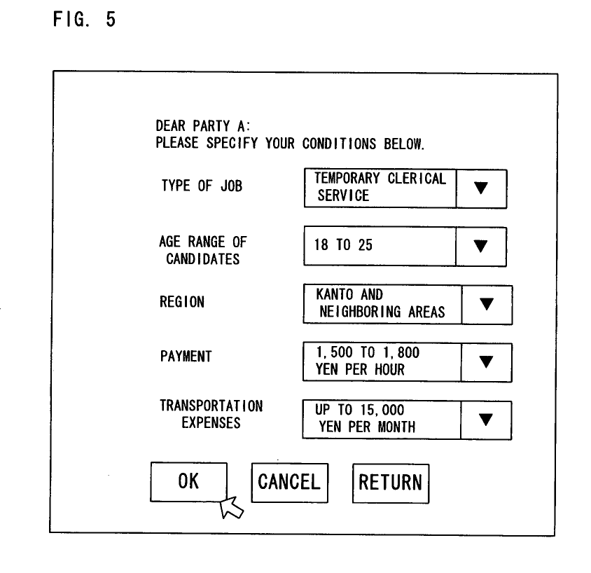

FIG. 5 to FIG. 9 show changes in a web-page browser screen display and an email screen display for user party A, serving as a user who recruits people on a web page of a temporary-staffing-service web site on the Internet where the above-described communication-address issuing apparatus is operating, and for parties B to J, and . . . , serving as dispatch staff registered in advance as temporary staff at a recruiting section of the web page, where user party A accesses a service that allows user party A to search for dispatch staff satisfying certain conditions based on user information about the dispatch staff [information about users serving as various types of dispatch staff is registered (in the user-data storage section 12) and at least the original addresses of the dispatch staff are included as the registered information (in the address-information storage section 11)] and to contact each of the qualified dispatch staff members by email without exposing the original address party A.

The screen display shown in FIG. 5 is a screen display basically shown on a browser of party A when party A access the above-described web page on the Internet, where this communication-address issuing apparatus is operating. At this time, party A does not use the communication-address issuing apparatus, but searches for communication partners by the use of the database function of a server where the URL of the web site is hosted. Here, an input screen for conditions desired for temporary staffing is displayed, and party A inputs conditions according thereto.

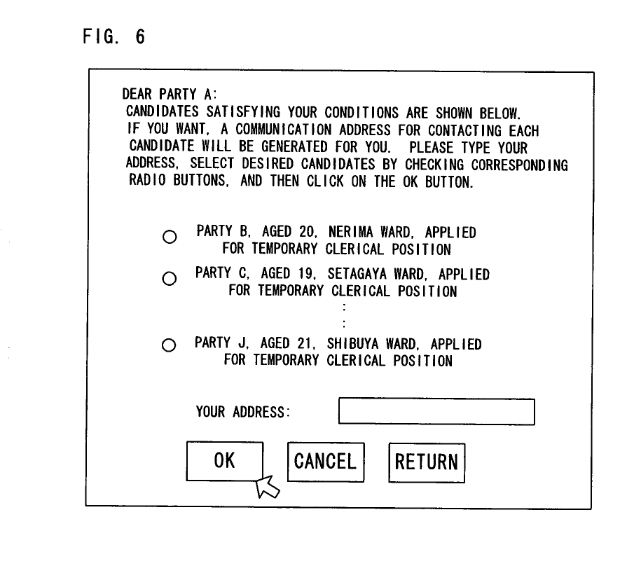

FIG. 6 is a screen displaying a search result of a conditional search. Here, some of the user information about parties B to J registered in advance as temporary staff are displayed on the screen based on the conditions specified by party A, and furthermore, the screen is configured so as to allow party A to select dispatch staff to make contact with, from among parties B to J. At this time, it is also required that party A's original address be input.

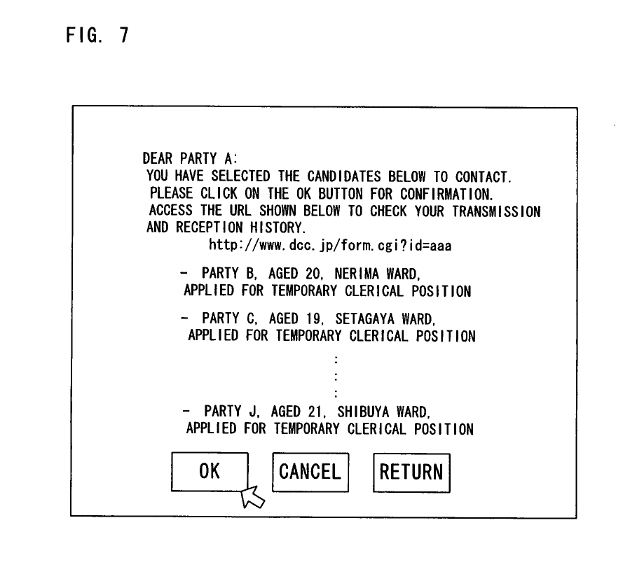

FIG. 7 is a selection-confirmation screen for partners with whom party A wishes to make contact. Here, when party A wishes to make contact with parties B to J by electronic mail, party A is required to click on the OK button. When the OK button is clicked on in this screen configuration, communication addresses are issued for party A and user parties B through J, serving as communication partners thereof, and are reported to these parties as described later. Since a transmission and reception history of party A is stored in a transmission-and-reception-history storage section 13, to be described later, a message “Access the URL shown below to check your transmission and reception history” is displayed on the screen display.

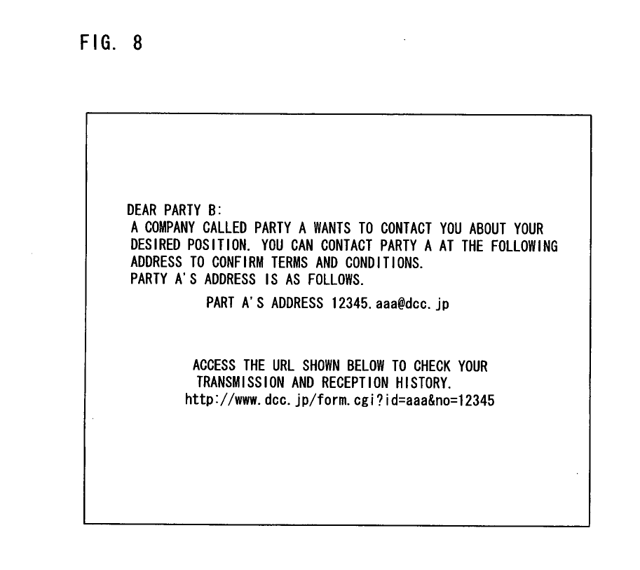

FIG. 8 is a screen displaying, for party B, a communication address for party A for exchanging emails with party A, so that party A and party B can make contact with each other. More specifically, when party A clicks on the OK button on the above-described screen configuration of FIG. 7, communication addresses are issued for party A and user parties B through J, serving as the communication partners thereof, and are reported to these parties. The screen displayed when the report arrives at party B's email program as an email to party B is the screen shown in FIG. 8. At this time, a communication address for party A from party B, which is used by party B to make contact (communicate) with party A, is displayed together.

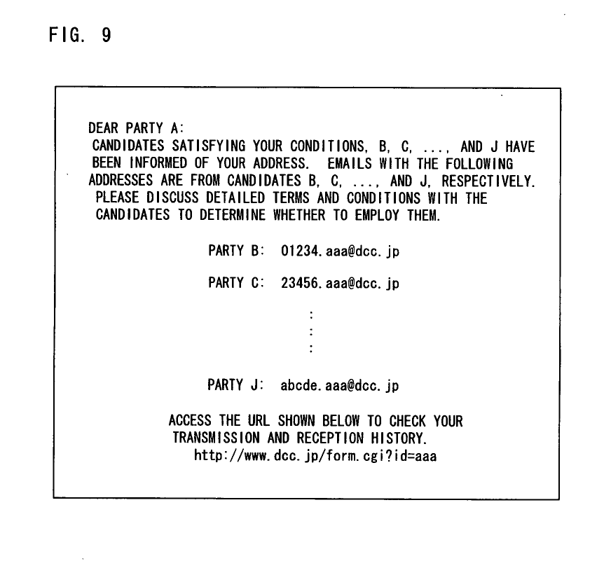

Similarly, FIG. 9 is a diagram showing contents of an email program screen of party A displayed when communication addresses to parties B through J are transmitted to party A. On this screen, party A can acquire the communication addresses to parties B through J without exposing the original address of party A to parties B to J. Hereinafter, party A transmits data such as emails to these parties B to J using the communication addresses shown on this screen.

### Second Embodiment

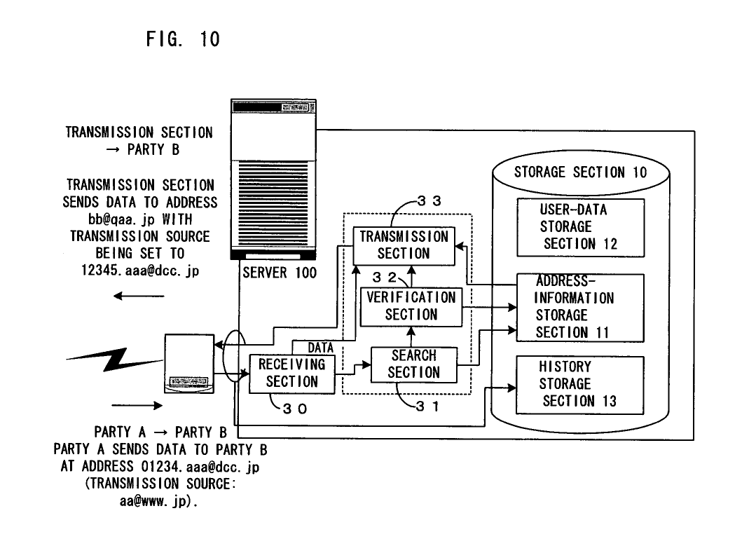

FIG. 10 is an outlined illustration of the structure of a communication-mediating apparatus according to the present invention, provided on the same server 100 as in the above-described first embodiment.

As shown in the figure, this communication-mediating apparatus also includes the CPU; the RAM; the hard disk drive; the communication apparatus; and other components of the server 100, as with the above-described communication-address issuing apparatus. More specifically, this communication-mediating apparatus includes an address-information storage section 11; a receiving section 30; a search section 31; a verification section 32; a transmission section 33; and a transmission-and-reception-history storage section 13.

Of these components, the receiving section 30, the search section 31, the verification section 32, and the transmission section 33 are formed of the CPU, which performs arithmetic and control processing according to a read-out program to allow this apparatus to function as a communication-address issuing apparatus; a RAM for providing a working area to the CPU and for storing flags and coefficient data required for arithmetic operations by the CPU and part of a program to be executed by the CPU to allow this apparatus to function as a communication-address issuing apparatus; and other components. The address-information storage section 11 and the transmission-and-. reception-history storage section 13 are formed of the above-described hard disk drive.

The address-information storage section 11 is configured so as to store an issued pair of communication addresses uniquely assigned to each pair of particular users, together with the original addresses of these users and information associating the pair of communication addresses, as described above (as in the first embodiment).

The receiving section 30 is configured so as to receive data sent to a communication address assigned for communication between particular users, together with the communication address and the transmission-source address.

The search section 31 is configured so as to search communication addresses stored in the address-information storage section 11 for an address identical to the communication address received by the receiving section 30.

The verification section 32 is configured such that, when an identical communication address is found as a result of the above-described search, it verifies the received transmission-source address with the original address stored in the address-information storage section 11, corresponding to the communication address.

The transmission section 33 is configured such that, when the transmission-source address matches the original address as a result of the verification made by the verification section 32, it reads out the other communication address which constitutes the pair with the communication address and which is stored in the address-information storage section 11 to set it as a transmission-source address and transmits the above-described data to the original address corresponding to the communication address.

The transmission-and-reception-history storage section 13 is configured so as to store a transmission and reception history of the receiving section 30 and transmission section 33 and make the transmission and reception history available for output.

In the structure of the first embodiment, since party B performs dispatch-staff registration (including the registration of information about party B's original address) in advance and party A performs selection and inputs its original address, the communication address 01234.aaa@dcc.jp to party B from party A and party A's original address aa@www.jp, as well as the communication address 12345.aaa@dcc.jp to party A from party B and party B's original address bb@qaa.jp, are stored in the address-information storage section 11.

Similarly, since party C performs dispatch-staff registration (including the registration of information about party C's original address) in advance and party A performs selection and inputs its original address, the communication address 23456.aaa@dcc.jp to party C from party A and party A's original address aa@www.jp, as well as the communication address 34567.aaa@dcc.jp to party A from party C and party C's original address cc@dff.jp, are stored in the address-information storage section 11.

Furthermore, since party J performs dispatch-staff registration (including the registration of information about party J's original address) in advance and party A performs selection and inputs its original address, the communication address abcde.aaa@dcc.jp to party J from party A and party A's original address aa@www.jp, as well as the communication address bcdef.aaa@dcc.jp to party A from party J and party J's original address zz@sss.jp, are stored in the address-information storage section 11.

Thus, as shown in FIG. 10, when party A sends data indicating, for example, the date for an interview with party B to party B at the communication address 01234.aaa@dcc.jp, with party A's original address aa@www.jp being set as the transmission source, the receiving section 30 temporarily receives the data.

Then, the search section 31 searches the communication addresses stored in the address-information storage section 11 for an address identical to the communication address 01234.aaa@dcc.jp received by the receiving section 30.

When the identical communication address 01234.aaa@dcc.jp is found as a result of the search, the verification section 32 verifies the received transmission-source address aa@www.jp with the original address stored in the address-information storage section 11, corresponding to the communication address 01234.aaa@dcc.jp.

When the transmission-source address aa@www.jp matches the original address aa@www.jp as a result of the verification made by the verification section 32, the communication in question is authenticated as a communication (data) from party A to party B. The transmission section 33 then reads out the other communication address 12345.aaa@dcc.jp, which constitutes the pair with the communication address 01234.aaa@dcc.jp and which is stored in the address-information storage section 11, to set it as the transmission-source address and transmits the data to the original address bb@qaa.jp corresponding to the communication address 12345.aaa@dcc.jp. Determination as to whether communication addresses constitute a pair is made by the verification section 32 based on the above-described associating information stored in the address-information storage section 11. More specifically, since the associating No. information in the information registered for registration No. 00001 is 00002, the information registered for registration No. 00002 is extracted, and thus the other (party B's) communication address 12345.aaa@dcc.jp and party B's original address bb@qaa.jp corresponding to the communication address 12345.aaa@dcc.jp are read out for the above-described process.

A transmission and reception history of the receiving section 30 and transmission section 33 is stored in the transmission-and-reception-history storage section 13, and the transmission and reception history is available for output upon request. This will be described in detail in a third embodiment discussed later.

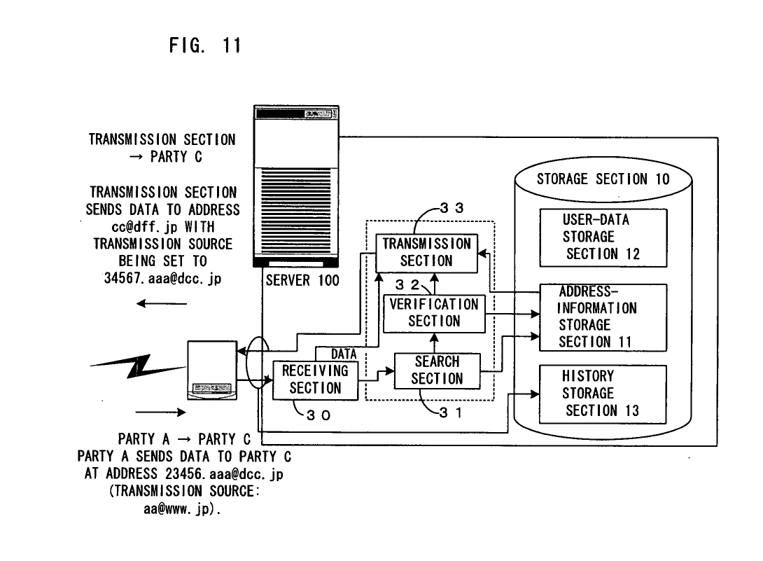

Similarly to FIG. 10, FIG. 11 shows communication mediating processing similar to that shown in FIG. 10, carried out by the communication-mediating apparatus when party A transmits data such as emails to party C.

More specifically, when party A sends data indicating, for example, the date for an interview with party C to party C at the communication address 23456.aaa@dcc.jp, with party A's original address aa@www.jp being set as the transmission source, the receiving section 30 temporarily receives the data.

Then, the search section 31 searches the communication addresses stored in the address-information storage section 11 for an address identical to the communication address 23456.aaa@dcc.jp received by the receiving section 30.

When the identical communication address 23456.aaa@dcc.jp is found as a result of the search, the verification section 32 verifies the received transmission-source address aa@www.jp with the original address stored in the address-information storage section 11, corresponding to the communication address 23456.aaa@dcc.jp.

When the transmission-source address aa@www.jp matches the original address aa@www.jp as a result of the verification made by the verification section 32, the communication in question is authenticated as a communication (data) from party A to party C. The transmission section 33 then reads out the other communication address 34567.aaa@dcc.jp, which constitutes the pair with the communication address 23456.aaa@dcc.jp and which is stored in the address-information storage section 11, to set it as the transmission-source address and transmits the data to the original address cc@dff.jp corresponding to the communication address 34567.aaa@dcc.jp.

A transmission and reception history of the receiving section 30 and transmission section 33 is stored in the transmission-and-reception-history storage section 13, and the transmission and reception history is available for output upon request. This will also be described in detail in the third embodiment, discussed later.

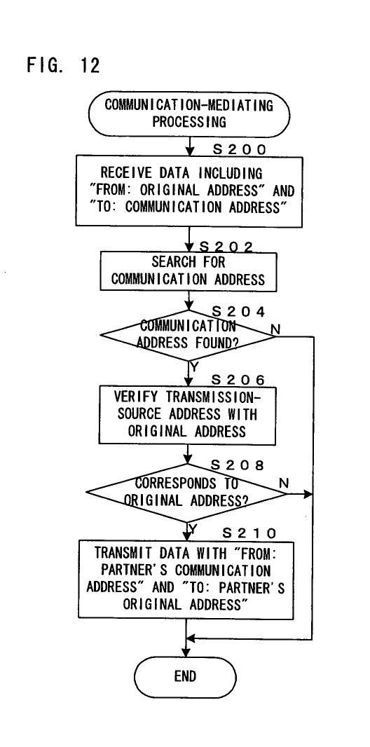

FIG. 12 is a flowchart of communication mediating processing in the communication-mediating apparatus.

As shown in the figure, for example, data including the communication address 01234.aaa@dcc.jp (indicated by “TO: communication address” in the figure) to party B from party A and party A's original address aa@www.jp (indicated by “FROM: original address” in the figure) is received by the receiving section 30 (step S200).

Next, the search section 31 searches for the communication address 01234.aaa@dcc.jp to party B from party A (step S202) and makes a search to see whether the communication address is stored in the address-information storage section 11 (step S204).

When the communication address 01234.aaa@dcc.jp to party B from party A is not stored in the address-information storage section 11 (No in step S204) as a result of this search, this processing ends at this point. When the communication address 01234.aaa@dcc.jp to party B from party A is stored in the address-information storage section 11 (Yes in step S204), the verification section 32 verifies the received transmission-source address aa@www.jp with the original address stored in the address-information storage section 11 (step S206).

Verification is performed to see whether these addresses match (step S208). When they do not match (No in step S208), this processing ends at this point. When these addresses match (Yes in step S208), the transmission section 33 reads out the other communication address 12345.aaa@dcc.jp, which constitutes the pair with the communication address 01234.aaa@dcc.jp, stored in the address-information storage section 11, to set it as the transmission-source address (indicated by “FROM: communication address” in the figure) and transmits the data to the original address bb@qaa.jp (indicated by “TO: original address” in the figure) corresponding to the communication address 12345.aaa@dcc.jp (step S210).

As described above, determination as to whether communication addresses constitute a pair is made by the verification section 32 based on the associating information stored in the address-information storage section 11. More specifically, since the associating No. information in the information registered for registration No. 00001 is 00002, the information registered for registration No. 00002 is extracted, and thus the other (party B's) communication address 12345.aaa@dcc.jp and party B's original address bb@qaa.jp corresponding to the communication address 12345.aaa@dcc.jp are read out for the above-described process.

### Third Embodiment

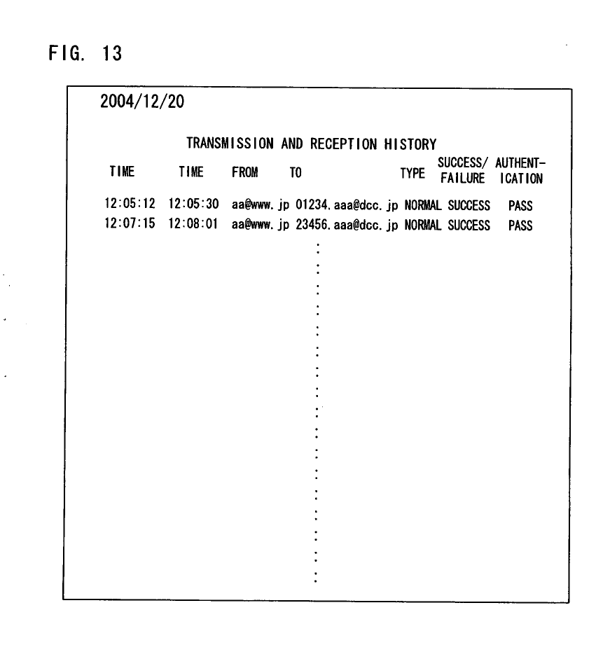

FIG. 13 to FIG. 16 show storage states of transmission and reception histories of the receiving section 30 and transmission section 33 in the transmission-and-reception-history storage section 13 according to the second embodiment, and processing in which the communication-address issuing apparatus issues a new communication address used for party B from party A and applies update processing thereof to the address-information storage section 11 when it is found by party A's check of the transmission and reception histories that a third party has impersonated party A to transmit data to party B.

FIG. 13 shows a storage state of a transmission and reception history of all communications taken by the receiving section 30 and transmission section 33 between party A and party J and stored in the transmission-and-reception-history storage section 13, as of Dec. 20, 2004. This has the same format as a normal communication log.

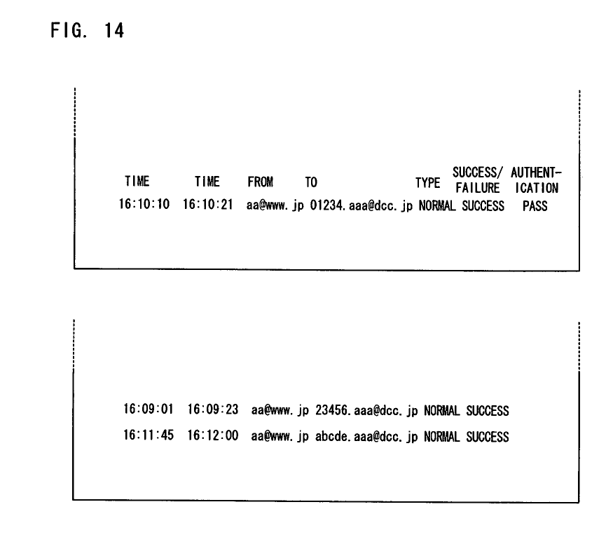

On the other hand, FIG. 14 shows states of a transmission and reception history in the transmission-and-reception-history storage section 13 (upper) and a transmission and reception history in the email program of party A (lower). As shown in the figure, a history entry not stored in the transmission and reception history of party A's email program is stored in the transmission-and-reception-history storage section 13, as a transmission and reception history in the transmission-and-reception-history storage section 13. More specifically, data is transmitted from a third party who is not stored in the history of party A to party B between 16:10:10 and 16:10:21. Although such a state is noticed by party A if party A periodically checks all communications in the transmission and reception history between party A and party J in the transmission-and-reception-history storage section 13, it can also be found when data not sent from party A is sent to other parties in the exchange of data, such as emails, between party A and party B, between party A and party C, . . . , and between party A and party J.

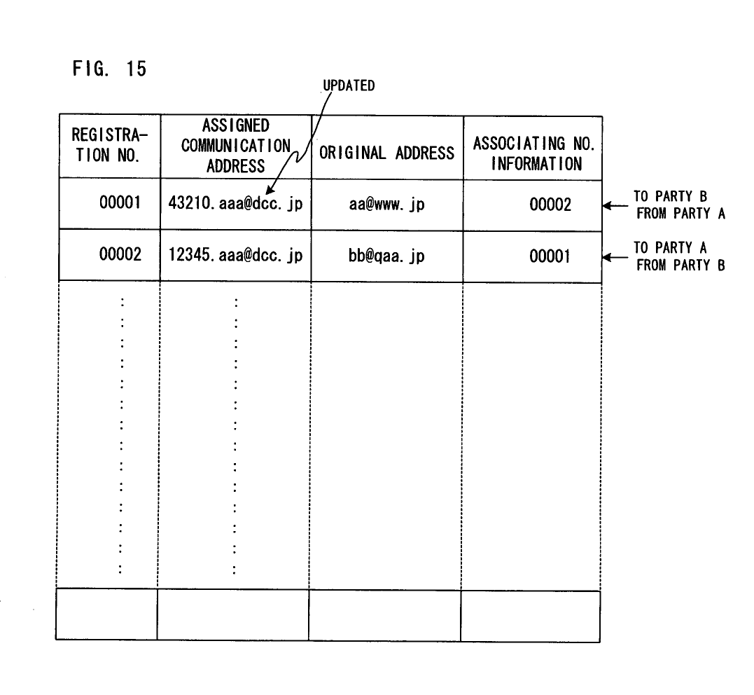

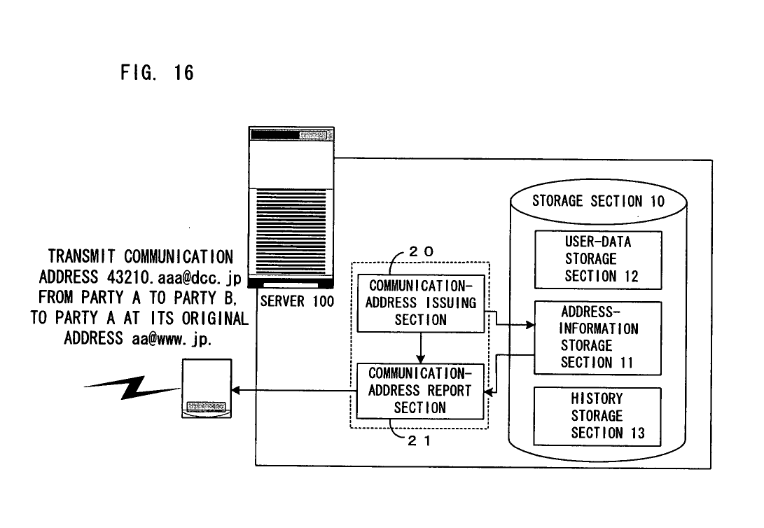

If this is the case, party A contacts an operator of the server 100 to ask the operator to operate the communication-address issuing section 20 of the communication-address issuing apparatus according to the first embodiment to issue another communication address for communication to party B from party A. Thereafter, the communication address for party B from party A in the address-information storage section 11 is updated from 01234.aaa@dcc.jp to 43210.aaa@dcc.jp by the communication-address issuing section 20 as shown in FIG. 15, and furthermore, the communication address 43210.aaa@dcc.jp for party B from party A is reported to party A at its original address aa@www.jp by the communication-address report section 21, as shown in FIG. 16.

According to the structure of the third embodiment, a transmission and reception history is stored in the transmission-and-reception-history storage section 13 and are available for output to users, including party A. Therefore, even if a third party forges the communication address 01234.aaa@dcc.jp to party B from party A and party A's original address aa@www.jp to impersonate party A, and transmits data to party B at the communication address 01234.aaa@dcc.jp, party A can find the impersonation made by the third party by checking the stored communication history (transmission and reception history), as described above.

When such impersonation made by a third party is found, one address in the pair of communication addresses issued (the communication address 01234.aaa@dcc.jp used by party A to communicate with party B in the example above) is modified. More specifically, the communication-address issuing section 20 issues a new communication address 43210.aaa@dcc.jp (for authentication of the side where modification is made) only for one address (01234.aaa@dcc.jp in the example above), and the address-information storage section 11 updates only the communication address to be modified (communication address used by party A to communicate with party B) to the new communication address 43210.aaa@dcc.jp and stores it. As a result, annoying work of changing a communication address is not imposed on party B on the other side, such as changing the address 12345.aaa@dcc.jp to another communication address. Furthermore, since a pair of communication addresses is uniquely assigned to each pair of particular users between whom mediation is to be made, and the pair of communication addresses is issued, it is not necessary to modify, for example, the communication address 23456.aaa@dcc.jp to party C from party A.

A communication-address issuing apparatus and a communication-mediating apparatus according to the present invention are not limited to the examples illustrated above, and various modifications thereof can be made within the scope of the present invention.

For example, the above-described apparatuses can use addresses for communications via, for example, so-called IP phones (Internet Protocol phones), as the above-described communication addresses (and original addresses). By doing so, one can communicate with a particular partner without exposing one's original telephone number or other information. In addition, one can communication with the partner after authentication. These enhance the security level.

In addition, for example, when a prize-contest advertisement is placed for people with particular preferences, if permission to provide a company with their address directory data (corresponding to the above-described communication addresses) is obtained, the present invention can be used to provide valuable information and advertisement information matching the preferences while preventing leaks from (the company) to a third party. This means that, from the original addresses of parties B to J shown at the right-hand side of FIG. 3, communication addresses for the side that has learned them (the above-described company) are re-issued and provided as such [namely, refine search data required to select people with particular preferences is stored in the user-data storage section 12 and the original addresses of the people and the re-issued communication addresses are registered in the address-information storage section 11].

### INDUSTRIAL APPLICABILITY

In a communication-address issuing apparatus, a communication-mediating apparatus, a communication-mediating method, a program, and a recording medium according to the present invention, addresses for communications via so-called IP phones (Internet Protocol phones), for example, can be used as communication addresses (and original addresses) to mediate communication not only for electronic mails but also for telephones. By doing so, one can communicate with a particular partner without exposing one's original telephone number or other information. In addition, one can communicate with the partner after authentication. These enhance the security level. Furthermore, the present invention can also be applied to cellular phones to which IP addresses can be assigned.

1: A communication-address issuing apparatus comprising:
communication-address issuing means for uniquely assigning one pair of communication addresses to each pair of particular users between whom mediation is made and issuing the pair of communication addresses together with associating information for the pair of communication addresses;
address-information storage means for storing the issued pair of communication addresses uniquely assigned to each pair of particular users, together with original addresses of the users and the associating information; and
communication-address report means for transmitting a unique pair of pieces of communication-address information for each pair of users to respective original addresses based on each of the pieces of storage information stored in the address-information storage means.

2: A communication-address issuing apparatus according to claim 1, wherein, when one of the issued pair of communication addresses is modified, the communication-address issuing means issues a new communication address only for the modified one, and the address-information storage means updates only the communication address to be modified to the new communication address and stores the new communication address.

3: A communication-mediating apparatus comprising:
address-information storage means for storing an issued pair of communication addresses uniquely assigned to each pair of particular users, together with original addresses of the users and associating information for the pair of communication addresses;
reception means for receiving data sent to a communication address assigned for communication between particular users, together with the communication address and the transmission-source address;
search means for searching communication addresses stored in the address-information storage means for an address identical to the communication address received by the reception means;
verification means for verifying the received transmission-source address with the original address stored in the address storage means corresponding to the communication address when an address identical to the communication address is found as a result of the searching; and
transmission means for reading out another communication address which constitutes the pair with the communication address and which is stored in the address-information storage means to set it as a transmission-source address and for transmitting the data to the original address corresponding to the communication address when the transmission-source address matches the original address as a result of the verification made by the verification means.

4: A communication-mediating apparatus comprising:
address-information storage means for storing an issued pair of communication addresses uniquely assigned to each pair of particular users, together with original addresses of the users and associating information for the pair of communication addresses;
reception means for receiving data sent to a communication address assigned for communication between particular users, together with the communication address and the transmission-source address;
search means for searching communication addresses stored in the address-information storage means for an address identical to the communication address received by the reception means;
verification means for verifying the received transmission-source address with the original address stored in the address storage means corresponding to the communication address when an address identical to the communication address is found as a result of the searching;
transmission means for reading out another communication address which constitutes the pair with the communication address and which is stored in the address-information storage means to set it as a transmission-source address and for transmitting the data to the original address corresponding to the communication address when the transmission-source address matches the original address as a result of the verification made by the verification means; and
transmission-and-reception-history storage means for storing a transmission and reception history of the reception means and the transmission means and making the transmission and reception history available for output.

5: A communication-mediating method executed with a structure including:
address-information storage means for storing an issued pair of communication addresses uniquely assigned to each pair of particular users, together with original addresses of the users and associating information for the pair of communication addresses;
reception means for receiving data sent to a communication address assigned for communication between particular users, together with the communication address and the transmission-source address;
search means for searching the address-information storage means for the communication address received by the reception means;
verification means for verifying the received transmission-source address with the original address stored in the address storage means corresponding to the communication address; and
transmission means for transmitting the data to an original address of the other user,
the communication-mediating method comprising the steps of:
receiving, with the reception means, data sent to a communication address assigned for communication between particular users, together with the communication address and the transmission-source address;
searching, with the search means, communication addresses stored in the address-information storage means for an address identical to the received communication address;
verifying, with the verification means, the received transmission-source address with the original address stored in the address storage means corresponding to the communication address when an address identical to the communication address is found as a result of the searching; and
reading out another communication address which constitutes the pair with the communication address and which is stored in the account-information storage means to set it as a transmission-source address and transmitting, with the transmission means, the data to the original address corresponding to the communication address when the transmission-source address matches the original address as a result of the verification.

6: A communication-mediating method executed with a structure including:
address-information storage means for storing an issued pair of communication addresses uniquely assigned to each pair of particular users, together with original addresses of the users and associating information for the pair of communication addresses;
reception means for receiving data sent to a communication address assigned for communication between particular users, together with the communication address and the transmission-source address;
search means for searching the address-information storage means for the communication address received by the reception means;
verification means for verifying the received transmission-source address with the original address stored in the address storage means corresponding to the communication address;
transmission means for transmitting the data to an original address of the other user; and
transmission-and-reception-history storage means for storing a transmission and reception history of the reception means and the transmission means,
the communication-mediating method comprising the steps of:
receiving, with the reception means, data sent to a communication address assigned for communication between particular users, together with the communication address and the transmission-source address;
searching, with the search means, communication addresses stored in the address-information storage means for an address identical to the received communication address;
verifying, with the verification means, the received transmission-source address with the original address stored in the address storage means corresponding to the communication address when an address identical to the communication address is found as a result of the searching;
reading out another communication address which constitutes the pair with the communication address and which is stored in the account-information storage means to set it as a transmission-source address and transmitting, with the transmission means, the data to the original address corresponding to the communication address when the transmission-source address matches the original address as a result of the verification; and
outputting the stored transmission and reception history, with the transmission-and-reception-history storage means, upon instruction to the transmission-and-reception-history storage means.

7: A computer program for issuing a communication address, the program being read and executed by a computer to cause the computer to function as:
communication-address issuing means for uniquely assigning one pair of communication addresses to each pair of particular users between whom mediation is made, and issuing the pair of communication addresses together with associating information for the pair of communication addresses;
address-information storage means for storing the issued pair of communication addresses uniquely assigned to each pair of particular users, together with original addresses of the users and the associating information; and
communication-address report means for transmitting a unique pair of pieces of communication-address information for each pair of users to respective original addresses based on each of the pieces of storage information stored in the address-information storage means.

8: A computer program according to claim 7, wherein, when one of the issued pair of communication addresses is modified, the communication-address issuing means issues a new communication address only for the modified one, and the address-information storage means updates only the communication address to be modified to the new communication address and stores the new communication address.

9: A computer program for mediating communication, the program being read and executed by a computer to cause the computer to function as:
address-information storage means for storing an issued pair of communication addresses uniquely assigned to each pair of particular users, together with original addresses of the users and associating information for the pair of communication addresses;
reception means for receiving data sent to a communication address assigned for communication between particular users, together with the communication address and the transmission-source address;
search means for searching communication addresses stored in the address-information storage means for an address identical to the communication address received by the reception means;
verification means for verifying the received transmission-source address with the original address stored in the address storage means corresponding to the communication address when an address identical to the communication address is found as a result of the searching; and
transmission means for reading out another communication address which constitutes the pair with the communication address and which is stored in the address-information storage means to set it as a transmission-source address and for transmitting the data to the original address corresponding to the communication address when the transmission-source address matches the original address as a result of the verification made by the verification means.

10: A computer program for mediating communication, the program being read and executed by a computer to cause the computer to function as:
address-information storage means for storing an issued pair of communication addresses uniquely assigned to each pair of particular users, together with original addresses of the users and associating information for the pair of communication addresses;
reception means for receiving data sent to a communication address assigned for communication between particular users, together with the communication address and the transmission-source address;
search means for searching communication addresses stored in the address-information storage means for an address identical to the communication address received by the reception means;
verification means for verifying the received transmission-source address with the original address stored in the address storage means corresponding to the communication address when an address identical to the communication address is found as a result of the searching;
transmission means for reading out another communication address which constitutes the pair with the communication address and which is stored in the address-information storage means to set it as a transmission-source address and for transmitting the data to the original address corresponding to the communication address when the transmission-source address matches the original address as a result of the verification made by the verification means; and
transmission-and-reception-history storage means for storing a transmission and reception history of the reception means and the transmission means and making the transmission and reception history available for output.

11: A computer-readable recording medium having stored therein the computer program according to claim 7.

12: A computer-readable recording medium having stored therein the computer program according to one of claim 8.

13: A computer-readable recording medium having stored therein the computer program according to one of claim 9.

14: A computer-readable recording medium having stored therein the computer program according to one of claim 10.
